(19) United States
(12) Patent Application Publication
(10) Pub. No.: US 2026/0246245 A1
(43) Pub. Date: Aug. 20, 2026

(54) METHOD AND APPARATUS FOR ENGAGING AN ELONGATE CABLE TO FACILITATE REPOSITIONING THEREOF

(71) Applicant: General Machine Products (KT), LLC, Trevose, PA (US)

(72) Inventors: Matthew A. Widtmann, Arlington Heights, IL (US); Karl Koederitz, Collegeville, PA (US); Russell Hackius, Churchville, PA (US); Brian Rodgers, Lower Gwynedd, PA (US)

(21) Appl. No.: 19/366,699

(22) Filed: Oct. 23, 2025

Related U.S. Application Data
(60) Provisional application No. 63/759,688, filed on Feb. 18, 2025.

(51) Int. Cl. H02G 1/04; G02B 6/48; H01B 9/00

(52) U.S. Cl. CPC H02G 1/04; G02B 6/48; H01B 9/005

(57) ABSTRACT

A gripping apparatus and method of engaging an elongate cable using the gripping apparatus. The gripping apparatus has relatively movable parts with at least three different states: (a) a first state in which the length of the cable can be placed in a starting relationship with the apparatus; b) a second state wherein the cable length resides in a volume between the relatively movable parts; and c) a third state wherein the volume of the second state is reduced and the cable length is captive between the relatively movable parts. The gripping apparatus is configured to be releasably maintained in the second state as an incident of the relatively movable parts being changed from the first state into the second state.

### CROSS-REFERENCE TO RELATED APPLICATIONS

This is a non-provisional application claiming priority to U.S. Provisional Application No. 63/759,688 filed Feb. 18, 2025.

### BACKGROUND OF THE INVENTION

### Field of the Invention

This invention relates to gripping apparatus that can be releasably engaged with a length of an elongate cable to allow a force exerted on the gripping apparatus to be applied to the elongate cable to facilitate repositioning thereof.

### Background Art

There are many environments in which elongate cables are placed aboveground and extended over substantial distances. Commonly, towers are strategically placed with cables supported by successive towers and unsupported between adjacent towers. It is often necessary to change the sag in the cables between adjacent towers, which requires that a discrete length thereof be gripped through an appropriate apparatus and repositioned.

As one example, optical ground cable (OPGW) is commonly installed aboveground on such towers. OPGW cables are commonly used in power utility transmission networks and placed at the tops of the towers, with the height that the OPGW cables connect being at locations 100 or more feet off the ground.

FIG. 1 shows an exemplary form of existing towers 10a, 10b, 10c with typical connecting locations for OPGW cable 12 at 14a, 14b, 14c.

As shown in FIG. 2, the connection locations 14 for the OPGW cables are a distance D from the top 16 of each tower 10. The distance D is generally on the order of 10-15 feet, thereby allowing workers ample room to engage the OPGW cable 12 and reposition the same to control sag and thus tension.

Commonly, gripping apparatus, identified in the trade as PocketBook grips, are used. This name attaches since the basic construction is such that the apparatus are manipulated as a book-selectively opening to allow engagement with a length of the OPGW cable and closed to effect clamping thereof. The gripping apparatus can then be repositioned to draw the OPGW cable therewith.

A conventional gripping apparatus is shown, in one specific form at 20 in FIGS. 2 and 3, and schematically in FIGS. 4-6, with limited detail, to show the basic operation thereof.

The gripping apparatus 20 has first and second plates 22, 24 that are overall generally flat and connected as book parts for pivoting movement relative to each other around an axis 26.

In FIG. 4, the plates 22, 24 are shown in an open state wherein a substantial volume at 27 is defined between oppositely facing surfaces 28, 30. This allows a discrete cable length L to be placed in the volume 27 between the surfaces 28, 30 by shifting the cable length L generally orthogonally to, and towards, the axis 26.

By then relatively moving the plates 22, 24 around the axis 26, the cable length L can be captured between the surfaces 28, 30. To effect this clamping, at least one connector 32, and in this case two connectors 32, are shown to act between the plates 22, 24, at a location spaced from the axis 26, and controlled to draw the plates surfaces 28, 30 towards each other to produce a clamping force on the cable length L.

As depicted, each of the connectors 32 consists of a threaded connector part/bolt 34 that is joined to the plate 24 for pivoting movement around an axis 36 that is parallel to the axis 26.

The connector parts 34, in the exemplary form being two in number, can each be pivoted to a starting position, as shown in dotted lines in FIG. 5, wherein the connector parts 34 are moved out of the path of the plate 22 as the relationship between the plates 22, 24 is changed from that in FIG. 4 to that in FIG. 5.

Once the FIG. 5 relationship between the plates 22, 24 is set, the connector parts 34 can be pivoted in the direction of the arrow 37 from the dotted line position into the solid line position, wherein each connector part 34 moves into a complementary slot 38 in the plate 22, exposing a distal end 39 thereof to be threadably engaged by a cooperating connecting part 40 which is shown as a conventional nut. The engaged connector parts 34, 40 can be tightened together to produce the desired clamping force on the cable length L.

The number of connectors 32 is dictated by the cable size and maximum pulling tension that may need to be applied to the gripping apparatus 20. Commonly, four, six, or nine connectors 32 are incorporated into the design.

As shown in FIGS. 2 and 3, a U-shaped bail 42 is connected fixedly to at least one of the plates 22, 24 and provides a structure as might be readily engaged by a hook 44 on a tensioning winch 46 braced against a tower 10.

Tensioning of OPGW cable presents a particular challenge. OPGW cable is a dual-purpose cable that carries not only current but, as shown in FIG. 7, also has a center fiber cable core C for telecommunications purposes. Because of the fiber optic core, this cable cannot be compressed by traditional tensioning grips with a large compressive force without the risk of core damage, and thus must have a special grip configuration that evenly distributes gripping loads around the cable perimeter, thereby avoiding flattening/crushing of the fiber optic core C.

As shown in FIG. 7, it is known to construct the surfaces 28, 30 of the plates 22, 24 to include discrete receptacle parts 48, 50 that, with the plates 22, 24 clamped closed as in FIG. 7, cooperatively produce a receptacle 52 with an effective diameter D1 substantially matched to the shape of the outer surface 54 of the cable length L, with the effective diameter D1 being slightly less than the effective diameter D2 of an outer surface 54 of the cable length L. This creates a substantially uniform compressive force around the outer surface 54, thereby reducing the likelihood of damage to the inner fiber core C of the cable. In other words, the cable length L is squeezed with a substantially uniform radial inward pressure around the surface 54 without crushing or pinching the fiber optic core C.

In a typical operation, the installer will climb to the top of a tower 10 and use or create an appropriate platform 56, as shown schematically in FIG. 2, from which to maneuver off of a side region near the top of the tower 10.

From this position, the worker will typically place the gripping apparatus 20 in the FIG. 4 state and shift it transversely over the cable length L, using one hand, and while balancing himself/herself and the gripping apparatus 20. The worker will use his/her other hand to “close” the plates 22, 24, while maintaining the cable length L in an appropriate aligned position with the receptacle 52, and thereafter pivot up the connector parts/bolts 32 and tighten them individually. This process is facilitated by loosely pre-threading the connector parts/nuts 40 onto the connecting parts/bolts 34, with them having adequate length that the connecting parts/bolts 34 can be pivoted into their respective slots 38 without having to separately handle and attach the connecting parts/nuts 40.

In short, the worker must strategically place the gripping apparatus 20 with respect to the cable length L, close the plates 22, 24 against each other, and initially pivot up at least one of the connector parts/bolts 34 so that the connector part(s)/nut(s) 40 overlie the plate 22 and can be tightened. This procedure is carried out while the worker balances himself/herself in a rather precarious position at an elevated height. The relationship between the gripping apparatus 20 and the length L of the cable 12 must be precisely maintained while tightening the connectors 32 to effect positive clamping without locally pinching or damaging the cable length L. This process is further aggravated by the fact that the plates 22, 24 generally have a relatively large mass and are relatively heavy since they are made from metal to be able to transmit large applied forces through the winch 46, or other structure.

The industry continues to seek out alternative designs that facilitate safe and efficient performance of the above-described procedures.

### SUMMARY OF THE INVENTION

In one form, the invention is directed to a method of engaging an elongate cable to facilitate repositioning of the elongate cable. The method includes the steps of: obtaining a gripping apparatus with first and second relatively movable parts; placing the first and second relatively movable parts in a first state; with the first and second relatively movable parts in the first state, placing a length of the elongate cable in a starting relationship with the gripping apparatus; changing the first and second relatively movable parts from the first state into a second state wherein the length of the elongate cable resides in a volume between the first and second relatively movable parts; causing the first and second relatively movable parts to be releasably maintained in the second state as an incident of the first and second relatively movable parts being changed from the first state into the second state; and with the first and second relatively movable parts releasably maintained in the second state, changing the first and second relatively movable parts into a third state wherein the volume between the first and second relatively movable parts is reduced from the volume between the first and second relatively movable parts with the relatively movable parts in the second state.

In one form, the gripping apparatus has separate detent components. The step of causing the first and second relatively movable parts to be releasably maintained in the second state involves causing the separate detent components to become engaged as an incident of the first and second relatively movable parts being changed from the first state into the second state.

In one form, the gripping apparatus has at least one spring that is loaded with a stored force as an incident of the first and second relatively movable parts being changed from the second state into the first state. The step of causing the first and second relatively movable parts to be releasably maintained in the second state involves causing the stored force in the loaded spring to be released as an incident of the first and second relatively movable parts being changed from the first state into the second state, whereupon the released stored force biases the first and second relatively movable parts into the second state to thereby cause the first and second parts to be releasably maintained in the second state.

In one form, with the first and second relatively movable parts in the second state, a first captive force is generated by the first and second relatively movable parts on the length of the cable residing between the first and second relatively movable parts. The captive force generated by the first and second relatively movable parts on the length of the cable residing between the first and second relatively movable parts in the third state is greater than the first captive force.

In one form, with the first and second relatively movable parts in the second state, the length of the cable residing between the first and second relatively movable parts is blocked from being separated from the gripping apparatus by being moved relative to the first and second relatively movable parts in a direction transversely to the length of the cable.

In one form, the elongate cable is an optical ground wire (OPGW).

In one form, the step of changing the first and second relatively movable parts from the first state into the second state involves moving at least one of the first and second relatively movable parts relative to the other of the first and second relatively movable parts around an axis.

In one form, the step of changing the first and second relatively movable parts from the second state into the third state involves moving at least one of the first and second relatively movable parts relative to the other of the first and second relatively movable parts around an axis.

In one form, the gripping apparatus has at least one connector. Each of the at least one connector has a connector part on the first relatively movable part configured to cooperate with a connector part on the second relatively movable part at a location spaced from the axis. The step of changing the first and second relatively movable parts from the second state into the third state involves engaging the connector part on the first relatively movable part with the connector part on the second relatively movable part.

In one form, the connector parts on the at least one connector are threadably engageable connector parts. The step of engaging the connector parts involves threadably tightening the connector parts together.

In one form, the at least one connector consists of at least two connectors.

In one form, the stored force in the at least one spring is a torsion force.

In one form, the gripping apparatus has a U-shaped bail that is fixed to at least one of the first and second relatively movable parts and configured to be engaged and repositioned with the length of the cable residing between the first and second relatively movable parts and the first and second relatively movable parts in the third state.

In one form, the method further includes the step of exerting a force on the U-shaped bail with the first and second relatively movable parts in the third state to thereby reposition the length of the cable.

In one form, one of the connector parts on the at least one connector is pivotably connected to one of the first and second relatively movable parts for movement between an operative position and a disengaged position.

In one form, with the one of the connector parts on the at least one connector in the operative position the other of the connector parts on the at least one connector is: a) threadably engaged with the one of the connector parts on the at least one connector; and b) tightened to change the first and second relatively movable parts from the second state into the third state.

In one form, the invention is directed to a gripping apparatus as used to perform the method described above.

In one form, the first and second relatively movable parts are connected for relative movement around an axis.

In one form, the gripping apparatus further includes at least one torsion spring that is loaded with a stored force as an incident of the first and second relatively movable parts being relatively moved around the axis from the second state into the first state, the stored force: a) released as an incident of the first and second relatively movable parts being changed from the first state into the second state; and b) releasably biasably causing the first and second relatively movable parts to be maintained in the second state.

In one form, the gripping apparatus has a detent component on one of the first and second relatively movable parts that engages with a detent component on the other of the first and second relatively movable parts, the detent components: a) engageable as an incident of the first and second relatively movable parts being changed from the first state into the second state; and b) once engaged, releasably maintaining the first and second relatively movable parts in the second state.

In one form, one of the detent components is movable between different positions and spring biased into one of the different positions.

In one form, the other of the detent components defines a receptacle for receiving a part of the one of the detent components with the first and second relatively movable parts in the second state and the one of the detent components biased into the one of the different positions.

In one form, the gripping apparatus has at least one connector. The at least one connector consists of a connector part on one of the first and second relatively movable parts that cooperates with a connector part on the other of the first and second relatively movable parts. The cooperating connector parts on the at least one connector are engageable to change the first and second relatively movable parts between the second state and the third state.

In one form, the connector parts on the at least one connector are threadably engageable connector parts that are engaged by being tightened to change the first and second relatively movable parts from the second state into the third state.

In one form, one of the connector parts on the at least one connector is pivotably connected to one of the first and second relatively movable parts for movement between an operative position and a disengaged position.

In one form, with the first and second relatively movable parts in the second state and the one of the connector parts on the at least one connector in the operative position, the one of the connector parts on the at least one connector extends through the other of the first and second relatively movable parts.

In one form, the gripping apparatus is provided in combination with an elongate cable, with a length of the elongate cable captive between the first and second relatively movable parts with the first and second relatively movable parts in the third state.

In one form, the length of the elongate cable has an outer surface with an effective diameter. The first and second relatively movable parts cooperatively define a receptacle for the length of the elongate cable having a complementary shape to the outer surface and an effective diameter less than the effective diameter of the outer surface of the length of the elongate cable.

In one form, the elongate cable is an optical ground wire (OPGW).

In one form, the gripping apparatus further includes a U-shaped bail that is fixed to at least one of the first and second relatively movable parts.

In one form, the gripping apparatus is provided in combination with a winch configured to: a) be engaged with the bail; and b) exert a force on the bail.

### BRIEF DESCRIPTION OF THE DRAWINGS

FIG. 1 is a perspective view of conventional towers with a wire connected thereto for aboveground support and representing one exemplary environment wherein the inventive gripping apparatus may be used;

FIG. 2 is an enlarged, fragmentary, partially schematic, elevation view showing a connection location for the wire on one of the towers in FIG. 1 and with a conventional gripping apparatus engaging the wire;

FIG. 3 is a perspective view of a conventional gripping apparatus as in FIG. 2;

FIG. 4 is a schematic, perspective view of a conventional gripping apparatus as in FIG. 3 and with a cable length between first and second parts that are joined for pivoting movement relative to each other around an axis;

FIG. 5 is an end elevation view of the components in FIG. 4;

FIG. 6 is an exploded view of a connector used to draw the first and second parts towards each other at a location spaced from the pivot axis;

FIG. 7 is an enlarged, fragmentary, end elevation view of a conventional gripping apparatus with first and second parts cooperatively defining a discrete volume for a cable length as shown also in FIG. 7;

FIG. 8 is a schematic representation of a gripping apparatus, according to the present invention;

FIG. 9 is a schematic representation showing additional details of first and second parts making up the gripping apparatus in FIG. 8;

FIG. 10 is a schematic representation of the first and second parts as in FIGS. 8 and 9 and showing components cooperating between the first and second parts to releasably maintain one state for the first and second parts;

FIG. 11 is a schematic representation of the first and second parts as shown in FIGS. 8-10 and showing at least one component that cooperates between the first and second parts to maintain a particular state thereof;

FIG. 12 is a schematic representation of a connector used to cooperate between the first and second parts, as shown in FIGS. 8-11, to change the relationship between the first and second parts;

FIG. 13 is an exploded perspective view of one specific form of the inventive gripping apparatus, as shown schematically in FIG. 8;

FIG. 14 is an enlarged, perspective view of the gripping apparatus in FIG. 13 in an assembled state and with first and second relatively movable parts thereon in a first state;

FIG. 15 is an end elevation view of the components in the FIG. 14 state;

FIG. 16 is a view as in FIG. 15 wherein the first and second parts have been changed to a second state;

FIG. 17 is a view as in FIG. 16 wherein the first and second parts have been changed to a third state;

FIG. 18 is a side elevation view of the component in the FIG. 17 state;

FIG. 19 is a plan view of a body used to make up the first and second parts on the gripping apparatus in FIGS. 13-18;

FIG. 20 is an end elevation view of the body in FIG. 19;

FIG. 21 is a side elevation view of the body in FIGS. 19 and 20;

FIG. 22 is a bottom view of the body in FIGS. 19-21;

FIG. 23 is a flow diagram representation of a method of engaging an elongate cable to facilitate positioning thereof, according to the invention;

FIG. 24 is a view as in FIG. 13 and showing a modified form of gripping apparatus, according to the invention;

FIG. 25 is an end elevation view of the gripping apparatus in FIG. 24 in an assembled state and with the first and second relatively movable parts thereon in a first state with one of the parts in the dotted line position and in a second state with the one part moved from the dotted line position into the solid line position;

FIG. 26 is a view as in FIG. 25 wherein the relatively movable parts have been changed to a third state;

FIG. 27 is a plan view of the apparatus in FIG. 26.

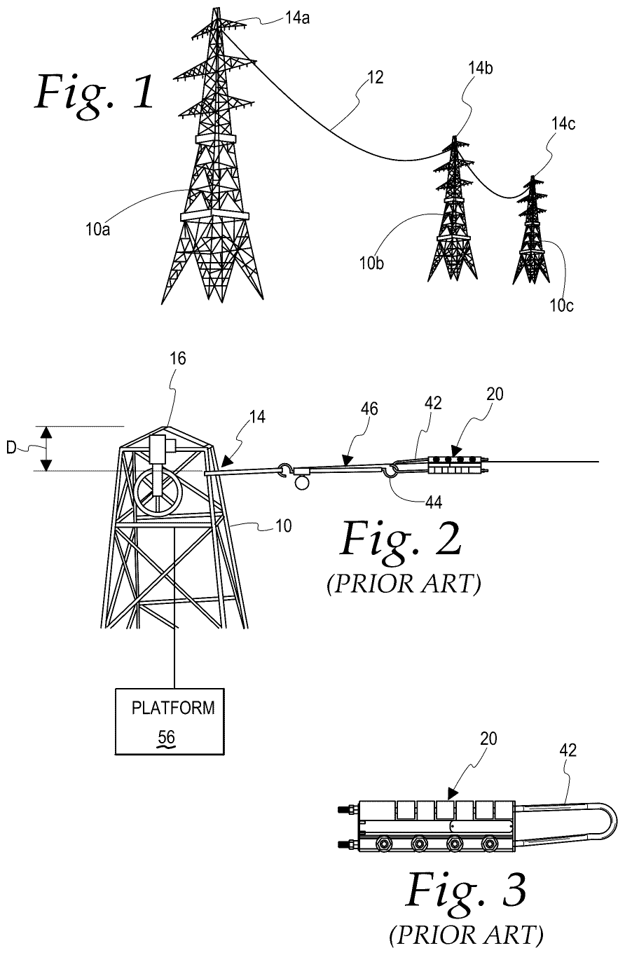

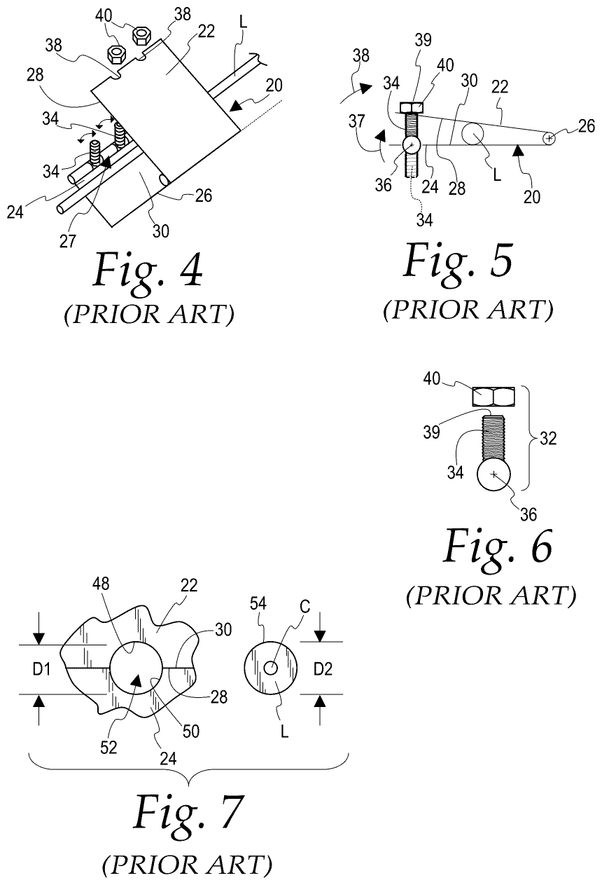

### DETAILED DESCRIPTION OF THE PREFERRED EMBODIMENT

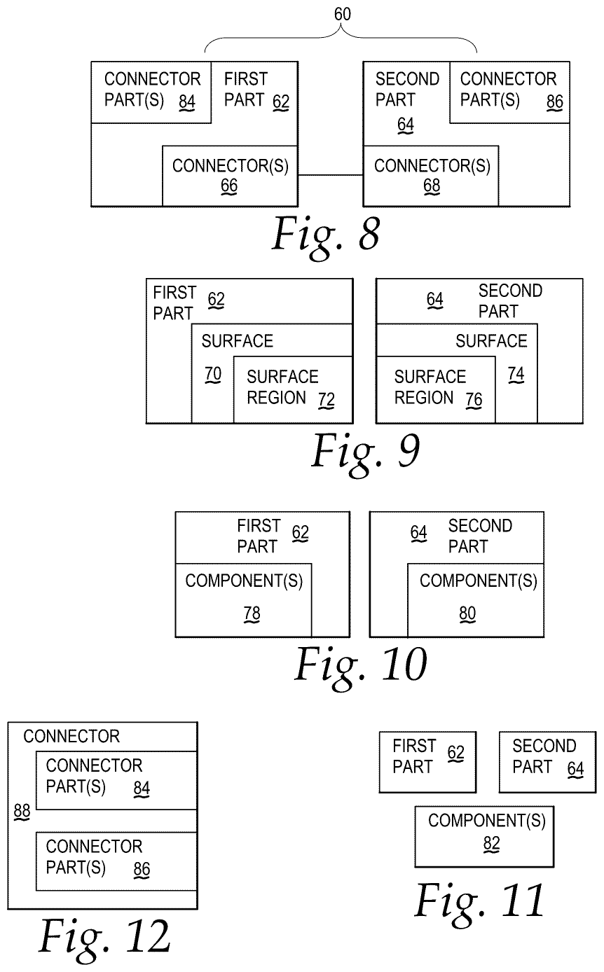

As shown schematically in FIG. 8, a gripping apparatus at 60, according to the present invention, consists of first and second relatively movable parts 62, 64, respectively, corresponding generally to the aforementioned first and second plates 22, 24. The first part 62 has at least one connector 66 that cooperates with at least one connector 68 on the second part 64 to guide relative movement of the parts 62, 64 between different states, as described below. The cooperating connectors 66, 68 may effect a simple pivot connection about a single axis or may have other configurations that allow the different states to be arrived at.

As shown in FIG. 9, the first part 62 has a surface 70 with a surface region 72 designed to engage the length L of the cable 12. The second part 64 has a surface 74 with a surface region 76 that is designed to engage the cable length L and cooperates with the surface region 72 to grip the cable length L.

The first and second parts 62, 64 are configured so that in a first relationship/state, the length L of the cable 12 can be placed in a starting relationship with the gripping apparatus 60, corresponding to being within the open pages of a book.

The first and second relatively movable parts 62, 64 are configured to be changed from the first state into a second relationship/state, wherein the length L of the cable 12 resides in a volume between the surfaces 70, 74.

The gripping apparatus 60 is configured so that the first and second parts 62, 64 can be releasably maintained in the second state. In one form, as shown in FIG. 10, there is at least one component 78 on the first part 62 that cooperates with at least one component 80 on the second part to releasably maintain the first and second parts 62, 64 in the second state.

Alternatively, as shown in FIG. 11, at least one component 82 itself cooperates between the first part 62 and the second part 64 to releasably maintain the first and second parts 62, 64 in the second state.

With the first and second parts 62, 64 in the second state, the first and second parts 62, 64 can be changed into a third state wherein the volume between the first and second surfaces 70, 74, and more preferably the volume between the surface regions 72, 76, is reduced.

This change to the third state is accomplished by using at least one connector part 84 on the first part 62, as shown in FIG. 12, that cooperates with at least one connector part 86 on the second part 64. The connector part 84 and connector part 86 together make up a connector 88.

The connector parts 84, 86 may have virtually an unlimited number of forms, including but not limited to, threadably engaged parts, that can be tightened to effect the aforementioned change of state of the first and second parts 62, 64.

The schematic depiction of parts in FIGS. 8-12 is intended to encompass virtually an unlimited number of different forms thereof and their interactions. One skilled in the art could devise different forms of each of the parts and different manners for their interaction. The specific forms below are intended to be exemplary in nature only and should not be viewed as limiting.

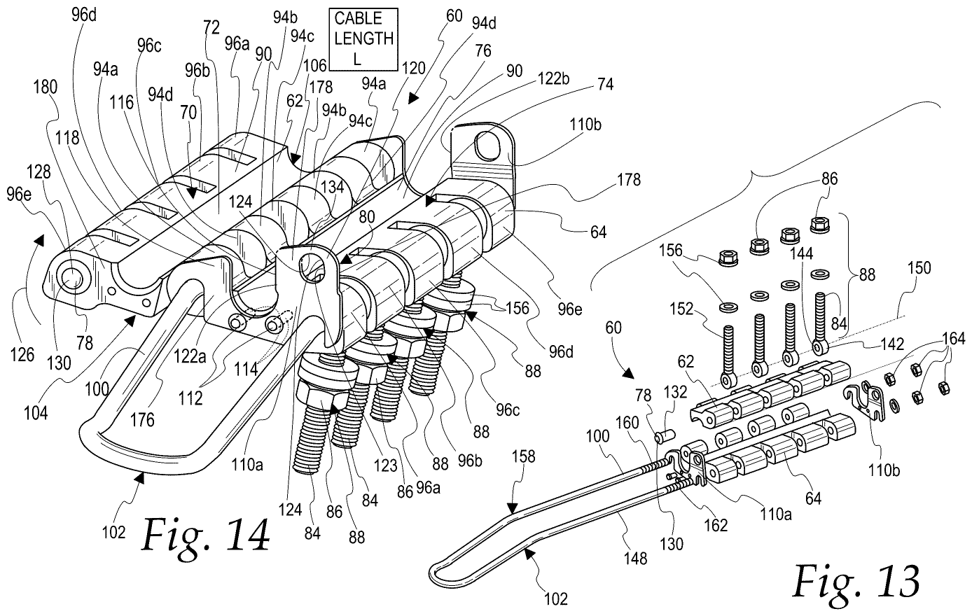

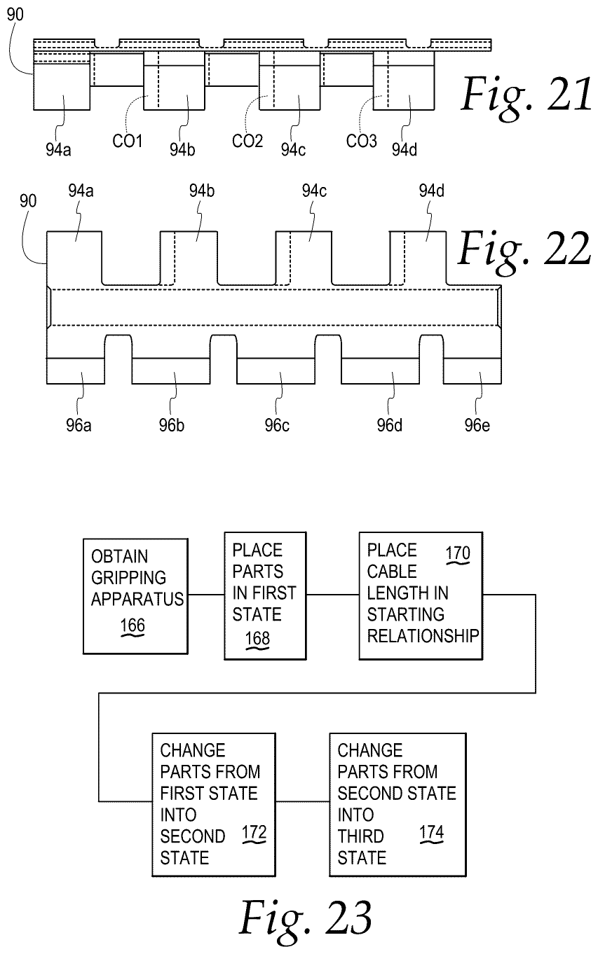

In FIGS. 13-22, an exemplary form of the gripping apparatus 60 is depicted.

The first part 62 has a generally rectangularly-shaped body 90. The second part 64, for purposes of manufacturing expedience, incorporates the same body 90 with different components added thereto than to the first body 62. Initially, it should be understood that the designation “first” and “second” in referencing the parts 62, 64 has no significance and the designation is intended to be used interchangeably.

The first part 62 has the aforementioned surface 70 with the second part 64 having the aforementioned surface 74.

The body 90, as shown separately in FIGS. 19-22, has a lengthwise central rib 92 with integral parts 94a, 94b, 94c, 94d projecting in one direction away from the rib 92 at spaced lengthwise locations, and integral parts 96a, 96b, 96c, 96d, 96e projecting oppositely away from the rib 92, also in spaced lengthwise relationship.

Receptacles 97a, 97b, 97c are successively defined between adjacent part pairs 94a, 94b; 94b, 94c; and 94c, 94d. A receptacle 97d is defined at the lengthwise end of the part 94d.

Receptacles 98a, 98b, 98c, 98d are defined successively between the part pairs 96a, 96b; 96b, 96c; 96c, 96d; and 96d, 96e.

In connecting the bodies 90 on the parts 62, 64, the separate bodies 90 are inverted lengthwise and aligned with each other so that the parts 94a, 94b, 94c, 94d on the body 90 on the first part 62 are meshed with the parts 94a, 94b, 94c, 94d on the body 90 on the second part 64, as seen in FIG. 14.

With the parts 94 of the bodies 90 meshed, a lengthwise bore 99 defined through the parts 94a, 94b, 94c, 94d on the body 90, making up the first part 62, aligns with the same bore 99 defined on the body 90 making up the second part 64. A leg 100 on a U-shaped bail 102, projecting from one lengthwise end 104 of the joined parts 62, 64, extends through the aligned bores 99 and fully through the combined parts 62, 64 to out the lengthwise end 106 of the combined parts 62, 64 that is opposite to the end 104 thereof.

With this arrangement, the parts 62, 64 are movable guidingly relative to each other around an axis 108 defined by the bail leg 100.

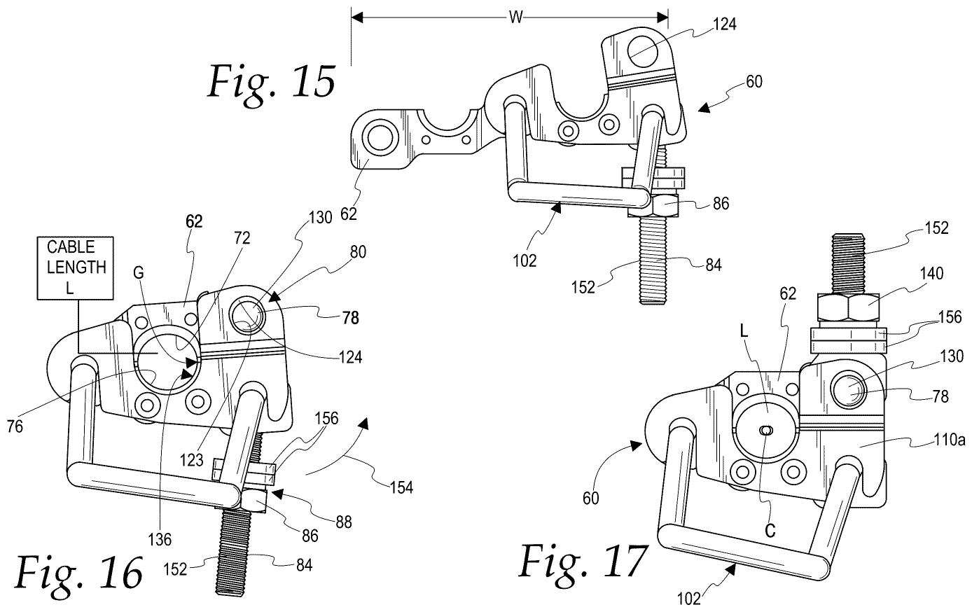

With this configuration, the first and second parts 62, 64 can be placed in a first state, as shown in FIGS. 14 and 15. This mimics an open book configuration which allows the aforementioned cable length L to be directed into a starting relationship with the gripping apparatus 60, wherein the cable length L is in widthwise overlapping relationship with the open gripping apparatus-with the width W identified in FIG. 15. This starting relationship of the cable length L with the gripping apparatus 60 actually covers a range of different widthwise relationships.

In one preferred starting relationship, the cable length L overlies and aligns with the concave surface region 76, identified schematically in FIG. 9, extending the length of the second part 64.

The same configuration of the body 90 on the first part 62 has the same configuration for the surface region 72, identified schematically in FIG. 9. The surface regions 72, 76 respectively have a shape that is nominally complementary to the shape of the outer surface 54 of the cable length L.

Separate plates 110a, 110b are provided, one each, at the lengthwise ends of the body 90 on the part 64. As depicted, each of the plates 110a, 110b has the same general shape, though this is not a requirement. The plate 110a is fixed to the body 90 on the second part 64 at the end 104 of the joined parts 62, 64 by threaded fasteners 112 that extend through the plate 110a into threaded bores 114 on the body 90.

In the first state for the parts 62, 64, as shown in FIGS. 14 and 15, the plate 110a defines an upwardly opening U-shaped receptacle 116, with the bottom of the receptacle 116 generally matching the contour of the surface region 76. A portion 118 of the plate 110a projects upwardly from the surface region 76 at one side thereof, with a separate portion 120 projecting further upwardly at the opposite side of the surface region 76.

The plate 110b is attached in the same orientation at the opposite lengthwise end 106 of the joined parts 62, 64. The plate 110b is made with a flat shape.

The plates 110 cooperatively facilitate guided movement of the cable length L into a starting relationship aligned over the surface region 76. Once the cable length L is in this starting relationship, the edge 122a bounding the receptacle 116, and the corresponding edge 122b on the plate 110b, additionally confine the cable length L against lateral shifting relative to the second part 64 to thereby avoid inadvertent separation of the cable length L from the gripping apparatus 60.

The plate 110a has a fully surrounded opening 123 bounded by an edge 124 that makes up part of the detent component 80, as shown schematically in FIG. 10.

With the cable length L in a starting relationship with the gripping apparatus 60, the first and second parts 62, 64 are changed from the first state into a second state, as shown in FIG. 16. More specifically, the first part 62 pivots in the direction of the arrow 126 in FIG. 14 around the axis 108 until the parts 62, 64 assume the second state of FIG. 16, wherein the concave surface regions 72, 76 open towards each other and cooperatively produce a substantially circular shape to accommodate a typical circular configuration for the outer surface 54 on the cable length L. A slight gap G may be present between the surface regions 72, 76, as seen from the FIG. 16 perspective.

In the second state, a detent component 78 on the first part 62, as shown schematically in FIG. 9, moves into the opening 123 surrounded by the edge 124 making up the cooperating component 80. In the exemplary form, the detent component 78 has a body 128 with a convex surface 130. The body 128 is contained within a cylindrical housing 132 which is press fit into a receptacle at an end of the body 90 on the first part 62. The body 128 is normally spring biased outwardly.

With the spring biased arrangement of the body 128, as the first and second parts 62, 64 are changed from the first state into the second state, a portion 134 of the wall portion 120 engages the convex end 130 of the body 128 and progressively cams the body 128 further into the housing 132 against a spring force to allow the convex end 130 of the body 128 to eventually register with the opening 123 bounded by the edge 124, whereupon the body 128 springs back to cooperate with the edge 124 to thereby releasably maintain the first and second parts 62, 64 in the aforementioned second state.

The holding force of the detent arrangement is preferably adequate to allow the user to reorient the gripping apparatus 60 while maintaining the second state of the first and second parts 62, 64, without having to manually exert a force on the parts 62, 64 to avoid their changing back into the aforementioned first state. At the same time, the force is not so great as to make it difficult to draw the first and second parts 62, 64 away from each other out of their second state when separation of the gripping apparatus 60 from the cable length L is desired.

As seen in FIG. 14-16, the edge 124 is elongate/oval in shape, which allows the detent components 78, 80 to be held together while allowing a slight relative pivoting between the first and second parts 62, 64 around the axis 108.

Accordingly, through a simple relative movement between the parts 62, 64, the first and second parts 62, 64 can be changed from the first state into the second state wherein they are releasably maintained through the detent arrangement.

In the second state, the cable length L is located within a volume at 136 bounded principally by the surface regions 72, 76.

With the first and second parts 62, 64 in the second state, a slight captive holding force may be applied to the cable length L within the volume 136. Alternatively, or additionally, the second state may have significance by reason of the gripping apparatus 60 being substantially safely confined, including by the edges 122a, 122b, in movement in any direction relative to the cable length L other than lengthwise therealong.

To change the first and second parts 62, 64 from the second state into the third state, the aforementioned connectors 88 are utilized.

The connectors 88 are substantially the same as the prior art connectors 32, described above. Each connector 88 consists of a connector part 84 in the form of a threaded bolt, and a cooperating connector part 86 in the form of a nut that threadably engages the connector part 84. The connector parts 84, 86 cooperate between the first and second parts 62, 64. While the connector parts 84, 86 are both shown on the second part 64, the connector part/nut 86 that engages the first part 62 will be considered to be part of the first part 62.

The connector parts/bolts 84 each has a flat head 142 that is movable into one of the receptacles/slots 98. Each of the heads 142 has a through opening 144. With each head 142 in its respective receptacle/slot 98, the through openings 144 align with a bore 146 (FIG. 20) that is directed lengthwise through each of the parts 96.

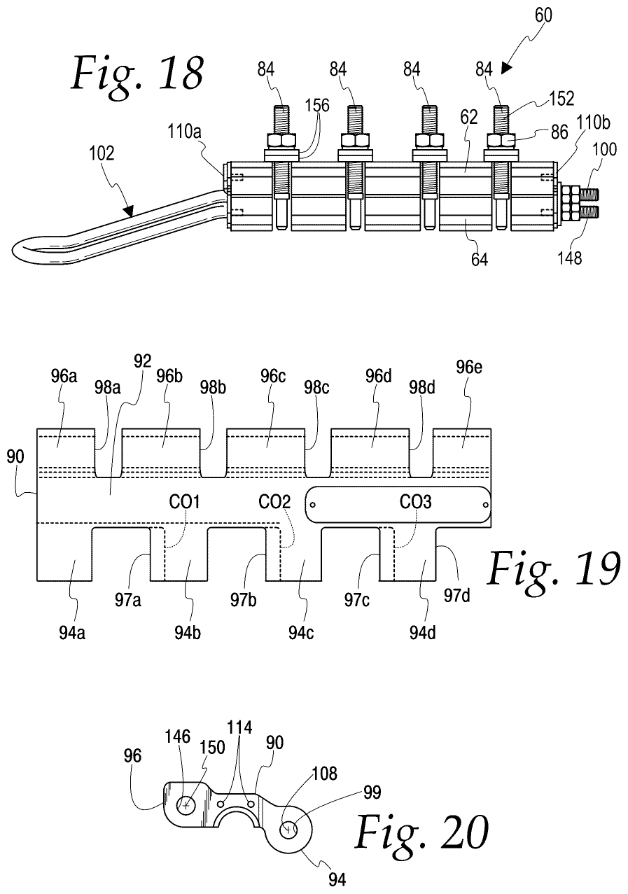

A separate leg 148 on the U-shaped bail 102 extends through the aligned openings 144 and bore 146 and projects to beyond the end 106 of the joined parts 62, 64. The leg 148 defines a pivot axis 150 for each of the connector parts/bolts 84. The connector parts/bolts 84, 86 are movable between a disengaged position, as shown in FIGS. 14-16, and an operative position, as shown in FIGS. 17 and 18.

In the operative position for the connector part/bolt 84, a threaded shaft 152 on each connector part/bolt 84 moves one each into the receptacles/slots 98 on the part 62 and a distal end thereof projects to above the part 62.

To facilitate use, the connector parts/nuts 86 can be loosely threaded to the connector parts/bolts 84, as shown in FIGS. 14-16. With the first and second parts 62, 64 in the second state of FIG. 16, the connector parts/bolts 84 can be pivoted in the direction of the arrow 154 in FIG. 16 around the axis 150 to place the connector parts/nuts 86 at the top of the part 62.

By then further engaging the connector parts/bolts 84 and connector parts/nuts 86, by tightening the connector parts/nuts 86, the part 62 is caused to further pivot in the direction of the arrow 126 around the axis 108 to thereby reduce the volume 136 to thereby cause a captive force, or an increased captive force, to be generated by the first and second parts 62, 64 on the cable length L.

The parts 62, 64 may be designed so that the magnitude of the captive force therebetween can be matched to a particular diameter of the cable length L. The design takes into consideration a positive gripping while avoiding damage to particularly the OPGW cable.

In the depicted form, four connectors 88 are utilized. The number is selected based upon the particular cable and gripping force required. It is common in the prior art to use four, six, or nine such connectors 88. It is conceivable that a single connector might be utilized and the invention might still be practiced.

In the depicted form, one or more washers 156 are interposed between the connector parts/nuts 86 and the part 62.

In the depicted form, the bail 102 has a bent “U” shape whereby with the bail 102 in an assembled position, a bend region at 158 is situated adjacent the end 104 of the combined parts 62, 64. The free ends 160, 162 of the legs 100, 148, respectively, are threaded and project through the end 106 of the joined parts 62, 64 to allow nuts 164 to be threadably engaged therewith to fix the bail 146 in its assembled position and capture the plate 110b against the base 90 of the part 64.

With the invention as described above, a method of engaging an elongate cable to facilitate repositioning of the elongate cable may be carried out as shown in flow diagram form in FIG. 23.

As shown at block 166, a gripping apparatus is obtained with first and second relatively movable parts.

As shown at block 168, the first and second relatively movable parts are placed in a first state.

As shown at block 170, with the first and second relatively movable parts in the first state, a length of the elongate cable is placed in a starting relationship with the gripping apparatus.

As shown at block 172, the first and second relatively movable parts are changed from the first state into a second state, wherein the length of the elongate cable resides in a volume between the first and second relatively movable parts. The first and second relatively movable parts are caused to be releasably maintained in the second state as an incident of the first and second relatively movable parts being changed from the first state into the second state.

As shown at block 174, with the first and second relatively movable parts releasably maintained in the second state, the first and second relatively movable parts are changed into a third state wherein the volume between the first and second relatively movable parts is reduced and a captive force, or an increased captive force, is generated by the first and second relatively movable parts on the length of the cable residing between the first and second relatively movable parts.

To avoid binding between the first and second parts 62, 64 as they are relatively moved, the wall portion 134, in which the edge 123 is formed on the plate 110a, is offset lengthwise from a main wall part 176 in a direction away from the end 104. As a result, a surface 178 on the wall portion 134 will clear the surface 180, on the body 90 on the first part 62, that it confronts as well as a projecting part of the housing 132, as the parts 62, 64 are changed between the first state and the second state and the wall portion 134 interacts with the component 78. The plate 110b is shown without any offset shape.

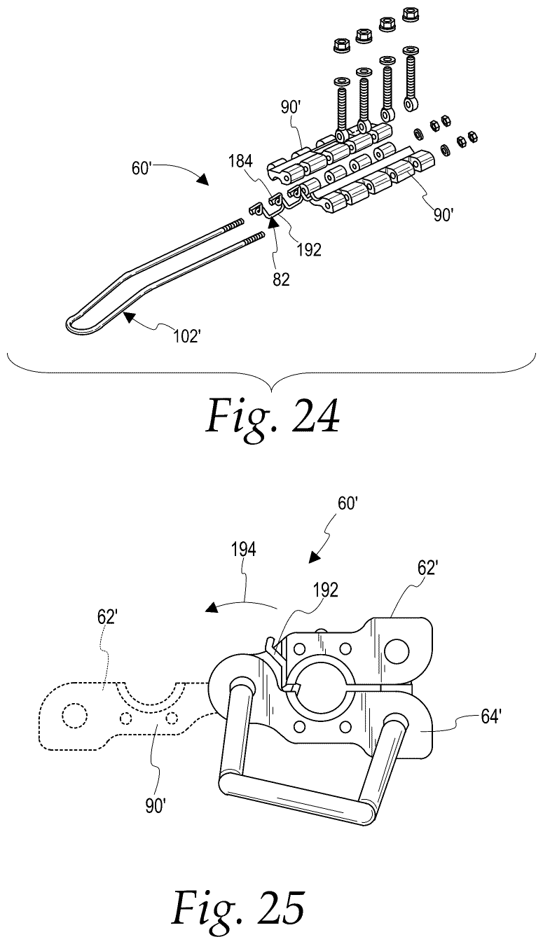

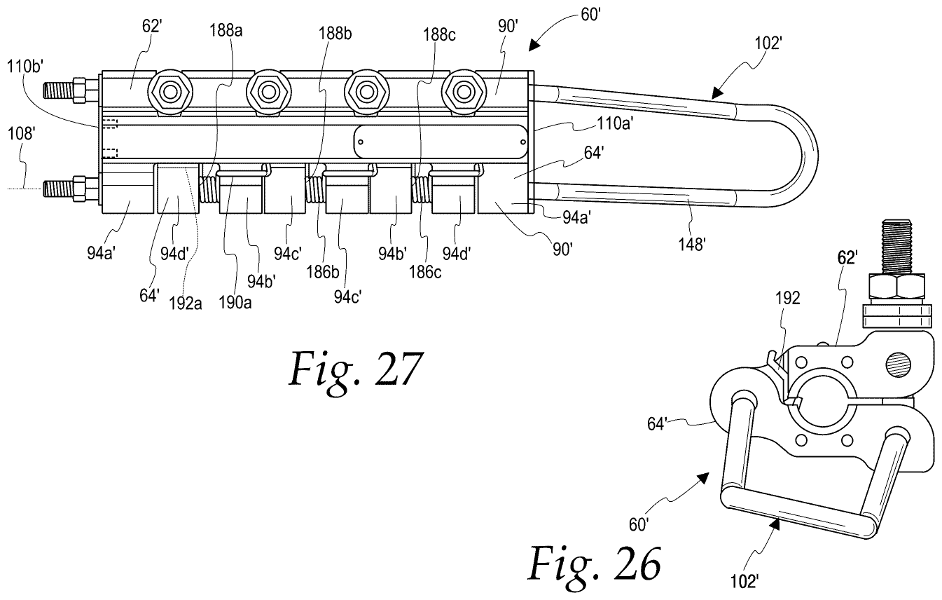

A modified form of the gripping apparatus is shown at 60′ in FIGS. 24-27, with corresponding parts identified with the same number and a “′” designation. The gripping apparatus 60′ is made with substantially the same construction as the gripping apparatus 60, with the main difference being that instead of incorporating cooperating detent components 78, 80 as on the gripping apparatus 60, a single component 82, as shown schematically in FIG. 11, cooperates between the first part 62′ and the second part 64′ to releasably maintain the first and second parts 62′, 64′ in the second state.

The component 82 is in the form of a torsion spring. The component/torsion spring 82 is formed as a continuous wire piece 184 with three spaced coils 186a, 186b, 186c. As seen most clearly in FIG. 27, the coils 186a, 186b, 186c reside successively in slots 188a, 188b, 188c.

The slots 188 are formed by narrowing the width of the projecting parts 94b′, 94c′, 94d′ on the body 90′ corresponding to the projecting parts 94b, 94c, 94d on the body 90, on the gripping assembly 60. This narrowing is indicated by showing “cutouts” CO1, CO2, CO3, successively on the projecting parts 94b, 94c, 94d, in FIGS. 19 and 20 in dotted lines. When the parts 62′, 64′ are meshed as described for the parts 62, 64, the slot 188a is defined between the parts 94d′, 94b′, the slot 188b is defined between the parts 94a′, 94c′, and the slot 188c is defined between the parts 94b′, 94d′.

The centers of the coils 186 surround the axis 108′, whereby the bail leg 148 projects therethrough to maintain the component 82 in an operative position.

The exemplary coil 188c has axially oppositely projecting arms 190a, 192a which bear against oppositely facing surfaces, respectively on the parts 62′, 64′. The arm 190a is shared with the coil 186b.

With reference to FIG. 25, with the part 62′ in the solid line position relative to the part 64′, the parts 62′, 64′ are in the aforementioned second state. Pivoting of the part 62′ in the direction of the arrow 194 around the axis 108 to the dotted line position, results in the parts 62′, 64′ realizing the aforementioned first state.

As an incident of changing the parts 62′, 64′ from the second state into the first state, the three separate coils 186 each is torsionally loaded with a stored force. The stored force is released as an incident of the first and second parts 62′, 64′ being released by the user. In response, the first and second parts 62′, 64′ change from the first state into the second state and become releasably biasably maintained in the second state.

With the parts 62′, 64′ in the second state, changing to the third state is achievable in the same manner as it is done with the gripping apparatus 60.

Plates 110a′, 110b′ may be attached at the ends as on the gripping apparatus 60. These plates may be flat or made with an offset.

The coils 186 are interconnected for purposes of convenience from a manufacturing and assembly standpoint. Individual torsion springs could be incorporated. Potentially a single coil 186 would be operable, depending upon the nature of the wire.

In the depicted form, the bodies 90, 90′ are configured to be usable with either one or more torsion springs or the detent feature. Further, both the torsion and detent features could be incorporated into the same design.

It should be understood that the basic concepts described herein could be used with different cables/wires. Further, the configuration of the surfaces 70, 74, shown schematically in FIG. 9 and that cooperate to engage the particular cable/wire, may be different than as shown herein. For example, a cable that does not have a fiber optic core might be captured between two flat surface regions 72, 76.

The bail 102 can be manually drawn or drawn as with the assistance of a tensioning device, such as the winch 46 depicted in FIG. 2.

The foregoing disclosure of specific embodiments is intended to be illustrative of the broad concepts comprehended by the invention.

1. A method of engaging an elongate cable to facilitate repositioning of the elongate cable, the method comprising the steps of:
obtaining a gripping apparatus with first and second relatively movable parts;
placing the first and second relatively movable parts in a first state;
with the first and second relatively movable parts in the first state, placing a length of the elongate cable in a starting relationship with the gripping apparatus;
changing the first and second relatively movable parts from the first state into a second state wherein the length of the elongate cable resides in a volume between the first and second relatively movable parts;
causing the first and second relatively movable parts to be releasably maintained in the second state as an incident of the first and second relatively movable parts being changed from the first state into the second state; and
with the first and second relatively movable parts releasably maintained in the second state, changing the first and second relatively movable parts into a third state wherein the volume between the first and second relatively movable parts is reduced from the volume between the first and second relatively movable parts with the first and second relatively movable parts in the second state.

2. The method of engaging an elongate cable according to claim 1 wherein the gripping apparatus comprises separate detent components and the step of causing the first and second relatively movable parts to be releasably maintained in the second state comprises causing the separate detent components to become engaged as an incident of the first and second relatively movable parts being changed from the first state into the second state.

3. The method of engaging an elongate cable according to claim 1 wherein the gripping apparatus comprises at least one spring that is loaded with a stored force as an incident of the first and second relatively movable parts being changed from the second state into the first state, and the step of causing the first and second relatively movable parts to be releasably maintained in the second state comprises causing the stored force in the loaded spring to be released as an incident of the first and second relatively movable parts being changed from the first state into the second state, whereby the released stored force biases the first and second relatively movable parts into the second state to thereby cause the first and second parts to be releasably maintained in the second state.

4. The method of engaging an elongate cable according to claim 1 wherein with the first and second relatively movable parts in the second state a first captive force is generated by the first and second relatively movable parts on the length of the cable residing between the first and second relatively movable parts, and the captive force generated by the first and second relatively movable parts on the length of the cable residing between the first and second relatively movable parts in the third state is greater than the first captive force.

5. The method of engaging an elongate cable according to claim 1 wherein with the first and second relatively movable parts in the second state the length of the cable residing between the first and second relatively movable parts is blocked from being separated from the gripping apparatus by being moved relative to the first and second relatively movable parts in a direction transversely to the length of the cable.

6. The method of engaging an elongate cable according to claim 1 wherein the elongate cable is an optical ground wire (OPGW).

7. The method of engaging an elongate cable according to claim 1 wherein the step of changing the first and second relatively movable parts from the first state into the second state comprises moving at least one of the first and second relatively movable parts relative to the other of the first and second relatively movable parts around an axis.

8. The method of engaging an elongate cable according to claim 1 wherein the step of changing the first and second relatively movable parts from the second state into the third state comprises moving at least one of the first and second relatively movable parts relative to the other of the first and second relatively movable parts around an axis.

9. The method of engaging an elongate cable according to claim 8 wherein the gripping apparatus comprises at least one connector, each of the at least one connector comprising a connector part on the first relatively movable part configured to cooperate with a connector part on the second relatively movable part at a location spaced from the axis, and the step of changing the first and second relatively movable parts from the second state into the third state comprises engaging the connector part on the first relatively movable part with the connector part on the second relatively movable part.

10. The method of engaging an elongate cable according to claim 9 wherein the connector parts on the at least one connector are threadably engageable connector parts and the step of engaging the connector parts comprises threadably tightening the connector parts together.

11. The method of engaging an elongate cable according to claim 9 wherein the at least one connector comprises at least two connectors.

12. The method of engaging an elongate cable according to claim 3 wherein the stored force in the at least one spring is a torsion force.

13. The method of engaging an elongate cable according to claim 1 wherein the gripping apparatus comprises a U-shaped bail that is fixed to at least one of the first and second relatively movable parts and configured to be engaged and repositioned with the length of the cable residing between the first and second relatively movable parts and the first and second relatively movable parts in the third state.

14. The method of engaging an elongate cable according to claim 13 and further comprising the step of exerting a force on the U-shaped bail with the first and second relatively movable parts in the third state to thereby reposition the length of the cable.

15. The method of engaging an elongate cable according to claim 10 wherein one of the connector parts on the at least one connector is pivotably connected to one of the first and second relatively movable parts for movement between an operative position and a disengaged position.

16. The method of engaging an elongate cable according to claim 15 wherein with the one of the connector parts on the at least one connector in the operative position the other of the connector parts on the at least one connector is: a) threadably engaged with the one of the connector parts on the at least one connector; and b) tightened to change the first and second relatively movable parts from the second state into the third state.

17. The gripping apparatus as used to perform the method of claim 1.

18. The gripping apparatus according to claim 17 wherein the first and second relatively movable parts are connected for relative movement around an axis.

19. The gripping apparatus according to claim 18 wherein the gripping apparatus further comprises at least one torsion spring that is loaded with a stored force as an incident of the first and second relatively movable parts being relatively moved around the axis from the second state into the first state, the stored force: a) released as an incident of the first and second relatively movable parts being changed from the first state into the second state; and b) releasably biasably causing the first and second relatively movable parts to be maintained in the second state.

20. The gripping apparatus according to claim 19 wherein the gripping apparatus comprises a detent component on one of the first and second relatively movable parts that engages with a detent component on the other of the first and second relatively movable parts, the detent components: a) engageable as an incident of the first and second relatively movable parts being changed from the first state into the second state; and b) once engaged, releasably maintaining the first and second relatively movable parts in the second state.

21. The gripping apparatus according to claim 20 wherein one of the detent components is movable between different positions and spring biased into one of the different positions.

22. The gripping apparatus according to claim 21 wherein the other of the detent components defines a receptacle for receiving a part of the one of the detent components with the first and second relatively movable parts in the second state and the one of the detent components biased into the one of the different positions.

23. The gripping apparatus according to claim 18 wherein the gripping apparatus comprises at least one connector, the at least one connector comprising a connector part on one of the first and second relatively movable parts that cooperates with a connector part on the other of the first and second relatively movable parts, the cooperating connector parts on the at least one connector engageable to change the first and second relatively movable parts between the second state and the third state.

24. The gripping apparatus according to claim 23 wherein the connector parts on the at least one connector are threadably engageable connector parts that are engaged by being tightened to change the first and second relatively movable parts from the second state into the third state.

25. The gripping apparatus according to claim 24 wherein one of the connector parts on the at least one connector is pivotably connected to one of the first and second relatively movable parts for movement between an operative position and a disengaged position.

26. The gripping apparatus according to claim 25 wherein with the first and second relatively movable parts in the second state and the one of the connector parts on the at least one connector in the operative position, the one of the connector parts on the at least one connector extends through the other of the first and second relatively movable parts.

27. The gripping apparatus according to claim 17 in combination with an elongate cable with a length of the elongate cable captive between the first and second relatively movable parts with the first and second relatively movable parts in the third state.

28. The gripping apparatus according to claim 27 wherein the length of the elongate cable has an outer surface with an effective diameter and the first and second relatively movable parts cooperatively define a receptacle for the length of the elongate cable having a complementary shape to the outer surface and an effective diameter less than the effective diameter of the outer surface of the length of the elongate cable.

29. The gripping apparatus according to claim 28 wherein the elongate cable is an optical ground wire (OPGW).

30. The gripping apparatus according to claim 17 wherein the gripping apparatus further comprises a U-shaped bail that is fixed to at least one of the first and second relatively movable parts.

31. The gripping apparatus according to claim 30 in combination with a winch configured to: a) be engaged with the bail; and b) exert a force on the bail.
